(19) United States
(12) Patent Application Publication
(10) Pub. No.: US 2017/0249998 A1
(43) Pub. Date: Aug. 31, 2017

(54) COMPOSITION AND METHOD FOR MANUFACTURING LARGE-GRAINED URANIUM OXIDE NUCLEAR FUEL PELLET

(71) Applicant: KEPCO NUCLEAR FUEL CO., LTD., Daejeon (KR)

(72) Inventors: Min Young CHOI, Daejeon (KR); Kwang Young LIM, Seoul (KR); Seung Jae LEE, Daejeon (KR); Yeon Soo NA, Daejeon (KR); Tae Sik JUNG, Daejeon (KR); Jae Ik KIM, Daejeon (KR); Yong Kyoon MOK, Daejeon (KR); Yoon Ho KIM, Daejeon (KR); Chung Yong LEE, Daejeon (KR); Hun JANG, Sejong-si (KR); Dae Gyun GO, Daejeon (KR); Sung Yong LEE, Daejeon (KR); Jong Sung YOO, Daejeon (KR)

(73) Assignee: KEPCO NUCLEAR FUEL CO., LTD., Daejeon (KR)

(21) Appl. No.: 15/277,270

(22) Filed: Sep. 27, 2016

(30) Foreign Application Priority Data
Feb. 25, 2016 (KR) 10-2016-0022797
Jul. 5, 2016 (KR) 10-2016-0084845

(51) Int. Cl. G21C 3/04; G21C 21/02; G21C 3/62

(52) U.S. Cl. CPC G21C 3/04; G21C 3/623; G21C 21/02; G21C 2003/045; G21Y 2004/40

(57) ABSTRACT

This invention relates to a composition and method for manufacturing a large-grained uranium oxide nuclear fuel pellet containing an additive. The nuclear fuel pellet is configured such that a uranium oxide powder and an additive powder composed of an Mg compound and a Si compound or Ca compound and a Al compound are mixed together, thus increasing a grain size to thus suppress the release of fission products, thereby increasing the stability of nuclear fuel, preventing cladding tubes from breaking, and contributing to the stable operation of nuclear power plants, ultimately increasing the overall stability of nuclear power plants including nuclear fuel.

### BACKGROUND OF THE INVENTION

1. Technical Field

The present invention relates to a composition and method for manufacturing a nuclear fuel pellet for use in a nuclear power plant and, more particularly, to a composition and method for manufacturing a large-grained uranium oxide nuclear fuel pellet containing an additive.

2. Description of the Related Art

Nuclear power industry uses heat generated from nuclear fission, and nuclear fuel is one of important elements used for nuclear power plants. Nuclear fuel which is used in industry is a cylindrical pellet that is produced by molding and sintering uranium (U) or plutonium (Pu) oxides, either alone or in combination.

For a widely used UO₂ nuclear fuel pellet, a powder is molded into a green pellet, and the green pellet is sintered at about 1700 to 1800° C. for 2 to 8 hr in a reducing gas atmosphere. The resulting grain size is the range of about 6 to 8 μm.

In order to safely use a UO₂ pellet in a nuclear power plant, a UO₂ pellet has to possess a relative density corresponding to 95% or more of a theoretical density, as well as a large grain size. This is because such a UO₂ pellet is more effective at decreasing the release of a fission product gas outside the UO₂ pellet to develop a high burn-up nuclear fuel in order to increase the economic efficiency of nuclear fuel, which is receiving attention at present.

With regard thereto, Korean Patent No. 10-0973498 discloses a pellet having a grain size of 13 to 15 μm, obtained by subjecting a UO₂ powder to low-temperature oxidation to give a U₃O₈ powder and mixing the U₃O₈ powder with an Al-containing powder and a UO₂ powder, thus preparing a granular powder, which is then produced into a green pellet, followed by sintering.

Korean Patent No. 10-0715516 discloses a large-grained UO₂ pellet, which is manufactured in a manner such that a UO₂ powder is subjected to compression molding to give a green pellet, which is then heated to a temperature of 1400° C. or higher in a weak oxidizing atmosphere or an inert gas atmosphere, sintered for 1 min or more in an air-mixed gas atmosphere, cooled to 1150 to 1250° C. in an oxidizing atmosphere or an inert gas atmosphere, reduced in a reducing atmosphere, and then cooled to room temperature.

U.S. Pat. No. 6,251,309 discloses a large-grained pellet manufactured by oxidizing defective UO₂ to produce a U₃O₈ monocrystal, which is then mixed with a UO₂ powder and sintered at 1600° C. or higher in a reducing atmosphere.

Korean Patent No. 10-1107294 discloses a large-grained UO₂ pellet manufactured by adding a UO₂ powder with an additive comprising Ti—Mg-mixed powder at a Ti/Mg weight ratio of 1.5 to 12 to produce a green pellet that is then sintered at 1600 to 1800° C. in a reducing gas atmosphere.

Korean Patent No. 10-1182290 discloses a large-grained pellet manufactured by oxidizing a UO₂ pellet or UO₂ pellet ground remnant to obtain a U₃O₈ powder, mixing the U₃O₈ powder with a Ni oxide and an Al oxide to give a mixed powder, which is then added to a UO₂ powder, molded into a green pellet, and sintered in a reducing atmosphere.

In order to increase the grain size of the UO₂ nuclear fuel pellet, methods of adjusting the sintering gas atmosphere, adding the U₃O₈ seed powder, or using the additive are known.

In the case where the U₃O₈ powder is produced to increase the grain size of the UO₂ pellet, the UO₂ powder is mixed with the U₃O₈ powder having a large specific surface area, and subsequently, a single-component Al oxide is added thereto. To this end, however, additional devices and procedures for obtaining a U₃O₈ powder are required, undesirably increasing manufacturing costs.

Moreover, in the case where the grain size is controlled by adjusting the sintering atmosphere, the processes become complicated due to gas replacement and changes in sintering temperature.

### CITATION LIST

### Patent Literature

(Patent Document 1) Korean Patent No. 10-0973498 (Registration date: Jul. 27, 2010)

(Patent Document 2) Korean Patent No. 10-0715516 (Registration date: Apr. 30, 2007)

### SUMMARY OF THE INVENTION

Accordingly, the present invention has been made keeping in mind the problems encountered in the related art, and the present invention is intended to provide a composition and method for manufacturing a large-grained pellet, wherein in order to decrease the release of a fission product gas from a high burnup nuclear fuel outside the UO₂ pellet and to prevent damage to pellet-cladding interaction (PCI), a UO₂ powder is mixed with an additive without additional processes or changes in processing atmosphere, thereby yielding a large-grained pellet, compared to conventional UO₂ nuclear fuel pellets.

Therefore, the present invention provides a nuclear fuel pellet, comprising a UO₂-based powder and an additive powder comprising an Mg compound and a Si compound, which are mixed together.

Preferably, the molar ratio of the Mg compound to the Si compound in the additive powder ranges from 5:95 to 95:5.

Preferably, the Mg compound and the Si compound are MgO and SiO₂, respectively.

In addition, the present invention provides a nuclear fuel pellet, comprising a UO₂-based powder and an additive powder comprising a Ca compound and an Al compound, which are mixed together.

Preferably, the molar ratio of the Ca compound to the Al compound in the additive powder ranges from 10:90 to 90:10.

Preferably, the Ca compound and the Al compound are CaCO₃ and Al₂O₃, respectively.

In addition, the present invention provides a method of manufacturing a UO₂ nuclear fuel pellet, comprising: mixing a UO₂-based powder with an additive powder comprising an Mg compound and a Si compound at a molar ratio ranging from 5:95 to 95:5, thus preparing a mixed powder, subjecting the mixed powder to compression molding, thus producing a green pellet, and sintering the green pellet at 1600 to 1850° C. in a reducing gas atmosphere.

Preferably, the Mg compound and the Si compound are MgO and SiO₂, respectively.

In addition, the present invention provides a method of manufacturing a UO₂ nuclear fuel pellet, comprising: mixing a UO₂-based powder with an additive powder comprising a Ca compound and an Al compound at a molar ratio ranging from 10:90 to 90:10, thus preparing a mixed powder, subjecting the mixed powder to compression molding, thus producing a green pellet, and sintering the green pellet at 1600 to 1850° C. in a reducing gas atmosphere.

Preferably, the Ca compound and the Al compound are CaCO₃ and Al₂O₃, respectively.

As such, the CaCO₃ powder may be sintered in a reducing gas atmosphere to thus be converted into CaO.

Preferably, the UO₂-based powder includes a UO₂ powder with or without at least one selected from the group consisting of a PuO₂ powder, a Gd₂O₃ powder, a ThO₂ powder, and an Er₂O₃ powder.

In the sintering, the reducing gas may be a hydrogen-containing gas.

Preferably, the hydrogen-containing gas is a mixed gas comprising a hydrogen gas and at least one gas selected from the group consisting of carbon dioxide, water vapor, and an inert gas, or the hydrogen-containing gas is composed of a hydrogen gas alone.

According to the present invention, a nuclear fuel pellet containing a mixture of an Mg compound and a Si compound or a mixture of a Ca compound and an Al compound is large-grained, thus suppressing the release of fission products, thereby increasing the stability of nuclear fuel, preventing cladding tubes from breaking, and contributing to the stable operation of a nuclear power plant, ultimately increasing the overall stability of the nuclear power plant including the nuclear fuel.

### BRIEF DESCRIPTION OF THE DRAWINGS

FIG. 1 is a block diagram showing a process of manufacturing a UO₂ nuclear fuel pellet according to the present invention;

FIG. 2 is an optical microscope image showing the grain structure of the UO₂ nuclear fuel pellet of Example 1-1 according to the present invention;

FIG. 3 is an optical microscope image showing the grain structure of the UO₂ nuclear fuel pellet of Example 1-2 according to the present invention;

FIG. 4 is an optical microscope image showing the grain structure of the UO₂ nuclear fuel pellet of Example 1-3 according to the present invention;

FIG. 5 is an optical microscope image showing the grain structure of the UO₂ nuclear fuel pellet of Example 2 according to the present invention;

FIG. 6 is an optical microscope image showing the grain structure of the UO₂ nuclear fuel pellet of Comparative Example 1 according to the present invention;

FIG. 7 is a phase diagram of MgO—SiO₂; and

FIG. 8 is a phase diagram of CaO—-Al₂O₃.

### DESCRIPTION OF SPECIFIC EMBODIMENTS

As disclosed in embodiments of the present invention, specific structures or functional explanations are merely set forth to illustrate exemplary embodiments according to the concept of the present invention. It will be understood that such exemplary embodiments are able to be variously modified, are not to be construed as limiting the present invention, and include all variations, equivalents and substitutions incorporated in the spirit and the scope of the present invention.

Hereinafter, a detailed description will be given of the present invention.

According to the present invention, a UO₂ pellet includes a mixture of an Mg compound and a Si compound, or a mixture of a Ca compound and an Al compound.

The total weight of the Mg compound and the Si compound is 0.01 to 0.5 wt %, and the molar ratio of Mg:Si ranges from 5:95 to 95:5. In this embodiment, an MgO powder and a SiO₂ powder are used. When the MgO powder and the SiO₂ powder are added at a molar ratio of 55:45, the largest amount of liquid is formed. Even if the molar ratio of these components falls out of the above range, the total addition amount thereof may be increased to thereby form the same amount of a grain-boundary liquid phase. Even when MgO and SiO₂ are directly added to the UO₂ powder within the molar ratio range of 95:5 to 5:95, it is possible to manufacture a similar nuclear fuel pellet. Most preferably, the molar ratio of MgO:SiO₂ is 55:45.

For reference, the Mg compound and the Si compound may be provided in the form of a nitride, carbide, sulfide, or phosphide, in addition to an oxide such as MgO and SiO₂.

Also, the total weight of the mixed powder of the Ca compound and the Al compound is 0.01 to 0.5 wt %, and the molar ratio of Ca:Al ranges from 10:90 to 90:10. In this embodiment, a CaCO₃ powder and an Al₂O₃ powder are used. CaO is formed using a method in which CaCO₃ is decomposed into CaO and CO₂ at 900° C. under an H₂ atmosphere. As such, CaCO₃ is added in the same amount as the amount of CaO that is desired. When the molar ratio of CaO:Al₂O₃ is 35:65, the largest amount of liquid is formed. Even if the molar ratio of these components falls out of the above range, the total addition amount thereof may be increased, thus forming the same amount of a grain-boundary liquid phase. Even when CaO and Al₂O₃ are directly added to the UO₂ powder within the molar ratio range of 10:90 to 90:10, it is possible to manufacture a similar nuclear fuel pellet. It is preferred that the molar ratio of CaO:Al₂O₃ is 35:65.

For reference, the Ca compound and the Al compound may be provided in the form of a nitride, carbide, sulfide, or phosphide, in addition to an oxide such as CaO and Al₂O₃.

Below is a description of the production of a UO₂ nuclear fuel pellet according to the present invention, comprising the above composition.

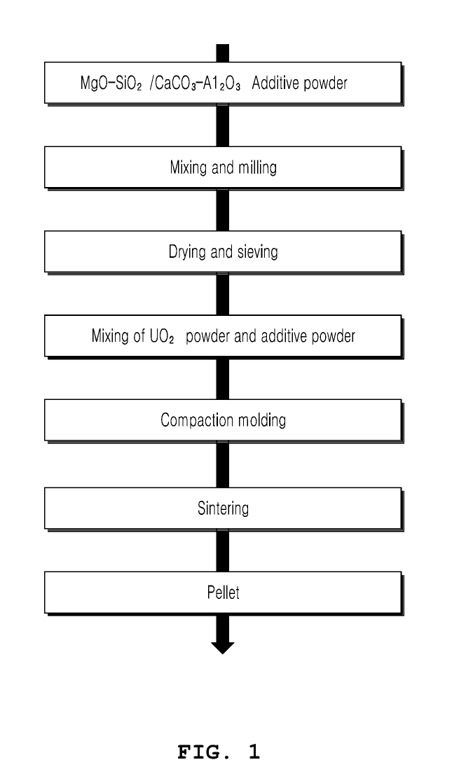

FIG. 1 is a flowchart schematically showing the process of manufacturing a nuclear fuel pellet according to an embodiment of the present invention. Individual steps thereof are specified below.

In Step 1, a mixed powder of an Mg compound and a Si compound or a mixed powder of a Ca compound and an Al compound is prepared. In this embodiment, additive compounds, namely MgO, SiO₂, CaCO₃, and Al₂O₃, are used.

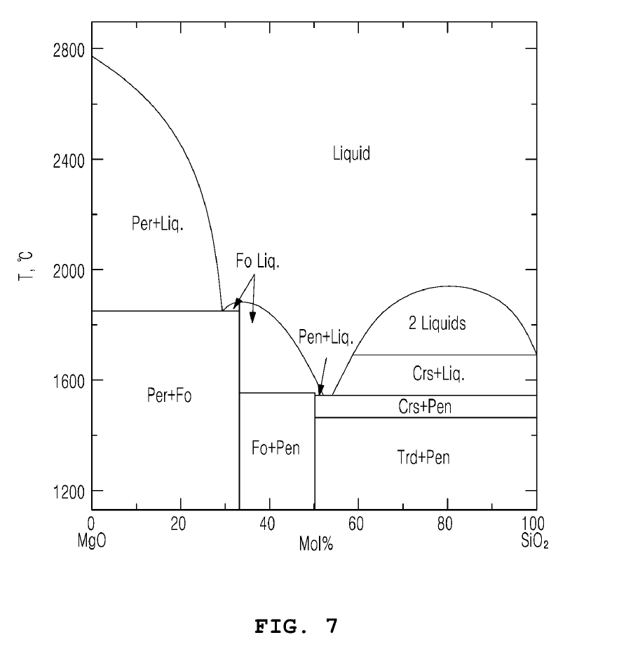

As shown in the phase diagram of MgO—SiO₂ of FIG. 7, each mixed powder is transformed into a liquid through a eutectic reaction at about 1550° C. When the molar ratio of MgO:SiO₂ is 55:45, the most complete liquid may be formed. When a UO₂ green pellet containing the above mixed powder is heated to a temperature of 1550° C. or higher, a liquid is formed and spreads along the UO₂ grain boundaries. Also, when the molar ratio of MgO:SiO₂ falls in the range of 95:5 to 5:95, the powders are mixed within the above range through a eutectic reaction, thus obtaining an additive compound. If the sintering temperature is lower than 1550° C., a liquid is not formed and thus a grain-boundary phase cannot result.

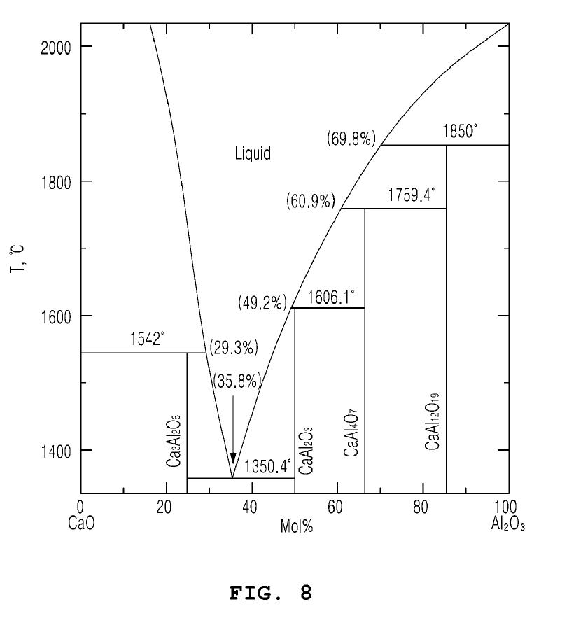

As shown in the phase diagram of CaO—Al₂O₃ of FIG. 8, each mixed powder is transformed into a liquid through a eutectic reaction at about 1600° C. When the molar ratio of CaO:Al₂O₃ falls in the range of 10:90 to 90:10, the powders are mixed within the above range through a eutectic reaction, thus obtaining an additive compound, and when the molar ratio thereof is 35:65, the most complete liquid may be formed. When a UO₂ green pellet containing the above mixed powder is heated to 1600° C. or higher, a liquid is formed and spreads along the UO₂ grain boundaries. If the sintering temperature is lower than 1600° C., a liquid is not formed and thus a grain-boundary phase cannot result.

In the aforementioned method of manufacturing the pellet, melting of the additive compound occurs near the sintering temperature, whereby the rate of material transfer is rapidly increased at the grain boundaries. During the sintering, the grain size of the pellet is increased due to the very fast material transfer.

In Step 2, the additive mixture obtained in Step 1 is mixed with a UO₂ powder, milled, dried and sieved, thus obtaining a mixed powder.

In Step 3, the mixed powder obtained in Step 2 is placed in a mold and produced into a green pellet under predetermined pressure.

In Step 4, the green pellet obtained in Step 3 is maintained at 1600 to 1850° C. for 2 to 10 hr in a reducing gas atmosphere, thus yielding a large-grained UO₂ pellet.

As such, the reducing gas may be a hydrogen-containing gas. Here, the hydrogen-containing gas may be a hydrogen gas composed exclusively of hydrogen, or may be provided in the form of a mixed gas comprising a hydrogen gas and at least one gas selected from the group consisting of carbon dioxide, water vapor, and an inert gas.

A better understanding of the present invention may be obtained through the following examples.

### EXAMPLE 1

In order to prepare an MgO—SiO₂ mixed powder, about 0.01 to 0.5 wt % of the mixed powder was made using components in the amounts shown in Table 1 below. An MgO powder and a SiO₂ powder were mixed at a predetermined ratio and milled together with alcohol and zirconia balls.

TABLE 1
<Molar ratio of Example 1>

| | Molar ratio of MgO:SiO₂ |
|---|---|
| Ex. 1-1 | 10:90 |
| Ex. 1-2 | 55:45 |
| Ex. 1-3 | 90:10 |

The mixed powder was dried, sieved, and mixed with a UO₂ powder. The resulting mixed powder was subjected to compression molding at a pressure of about 1 to 3 ton/m², thus producing a green pellet. The green pellet was sintered at 1700° C. for 2 hr in a reducing atmosphere.

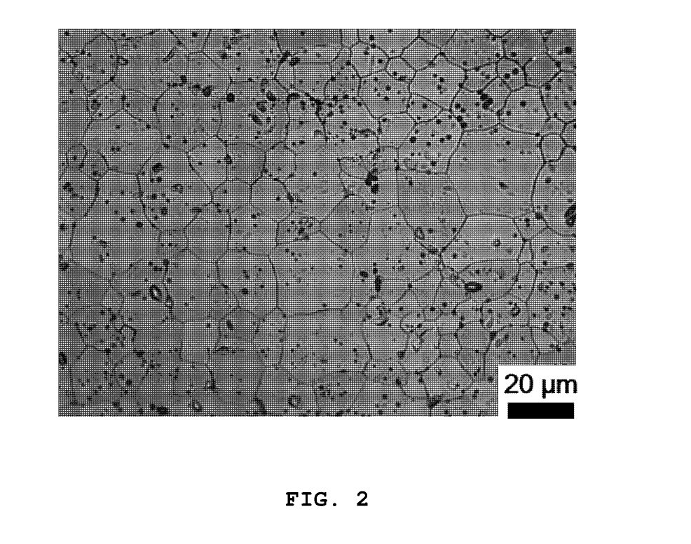

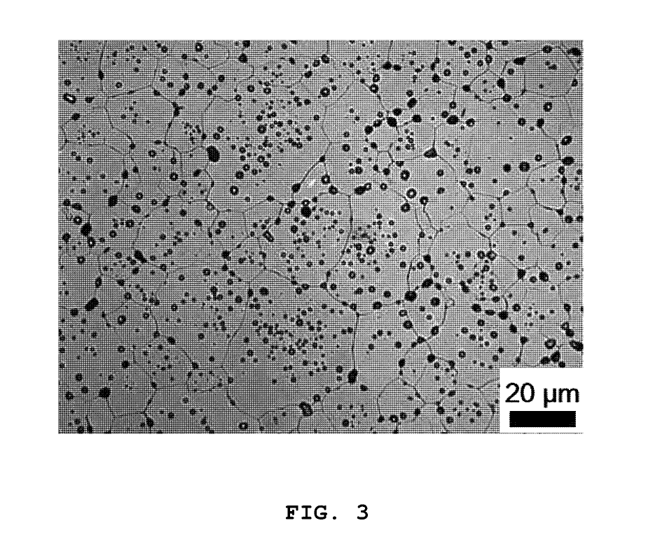

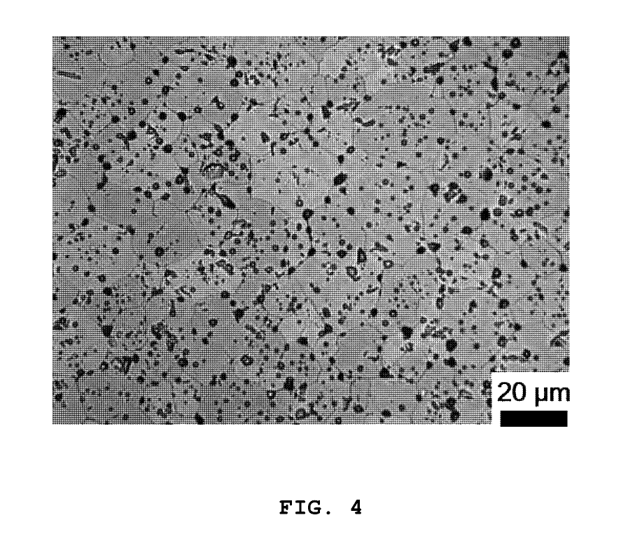

The density of the pellet thus manufactured was measured using a hydrostatic weighing method, after which the cross-section of the pellet was polished and thermally etched, followed by observing the grain structure. The grain size of the pellet was measured using a mean linear intercept method. The properties of the pellet are shown in Table 2 below, and FIGS. 2 to 4 show the grain structures of the pellets manufactured as above.

TABLE 2
<Properties of pellet of Example 1>

| | Relative density of UO₂ | Grain size of UO₂ |
|---|---|---|
| | pellet (%) | pellet (μm) |
| Ex. 1-1 | 96.8 | 19 |
| Ex. 1-2 | 95.4 | 34 |
| Ex. 1-3 | 96.4 | 23 |

### EXAMPLE 2

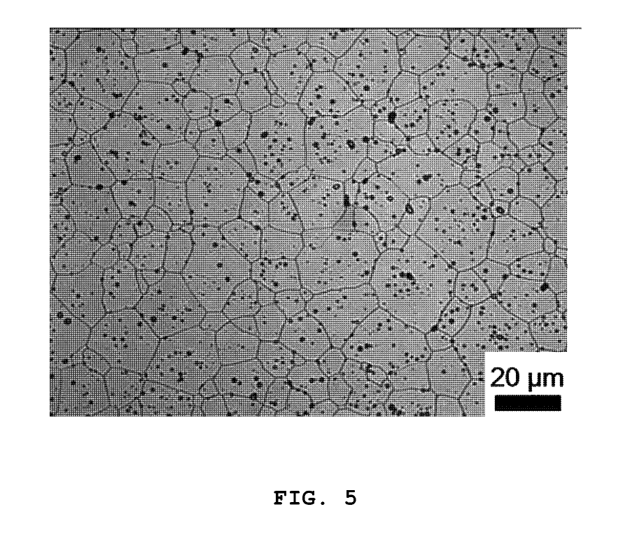

In order to manufacture a CaO—Al₂O₃ mixed powder, a composition comprising 35 mol % CaO-65 mol % Al₂O₃ was selected, and about 0.01 to 0.5 wt % of a mixed powder comprising CaCO₃ and Al₂O₃ was prepared, and was then manufactured into a pellet in the same manner as in Example 1. The density of the pellet thus manufactured was measured using a hydrostatic weighing method, after which the cross-section of the pellet was polished and thermally etched, followed by observing the grain structure. The grain size of the pellet was measured using a mean linear intercept method. The properties of the pellet are shown in Table 3 below, and FIG. 5 shows the grain structure of the pellet manufactured as above.

TABLE 3
<Properties of pellet of Example 2>

| Relative density of UO₂ | Grain size of UO₂ |
|---|---|
| pellet (%) | pellet (μm) |
| 97.3 | 20 |

### COMPARATIVE EXAMPLE 1

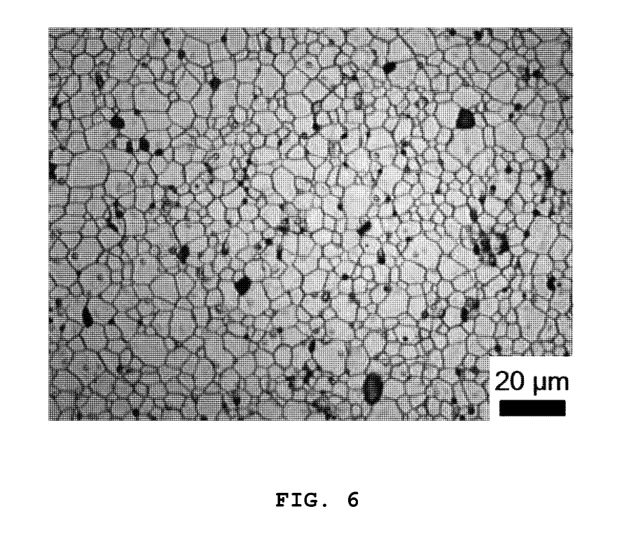

For comparison with the above Examples, a UO₂ pellet alone, without any additive, was manufactured in the same manner as in the above Examples. The properties of the pellet thus manufactured are shown in Table 4 below, and FIG. 6 shows the grain structure of the pellet manufactured as above.

TABLE 4
<Properties of pellet of Comparative Example 1>

| Relative density of UO₂ | Grain size of UO₂ |
|---|---|
| pellet (%) | pellet (μm) |
| 93.6 | 8 |

The pellets of Examples had a relative density of 95% or more, which was higher than that of the pellet of Comparative Example. Also, the grain size of Examples was found to be 20 to 34 μm, which was about 3 to 4 times greater than 8 μm of the pellet of Comparative Example.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A nuclear fuel pellet, comprising a uranium oxide powder and an additive powder comprising an Mg compound and a Si compound, which are mixed together.

2. The nuclear fuel pellet of claim 1, wherein a molar ratio of the Mg compound to the Si compound in the additive powder ranges from 5:95 to 95:5.

3. The nuclear fuel pellet of claim 1, wherein the Mg compound and the Si compound are MgO and SiO₂, respectively.

4. A nuclear fuel pellet, comprising a uranium oxide powder and an additive powder comprising a Ca compound and an Al compound, which are mixed together.

5. The nuclear fuel pellet of claim 4, wherein a molar ratio of the Ca compound to the Al compound in the additive powder ranges from 10:90 to 90:10.

6. The nuclear fuel pellet of claim 4, wherein the Ca compound and the Al compound are CaCO₃ and Al₂O₃, respectively.

7. A method of manufacturing a UO₂ nuclear fuel pellet, comprising:
mixing a uranium oxide powder with an additive powder comprising an Mg compound and a Si compound at a molar ratio ranging from 5:95 to 95:5, thus preparing a mixed powder;
subjecting the mixed powder to compression molding, thus producing a green pellet; and
sintering the green pellet at 1600 to 1850° C. in a reducing gas atmosphere.

8. The method of claim 7, wherein the Mg compound and the Si compound are MgO and SiO₂, respectively.

9. A method of manufacturing a UO₂ nuclear fuel pellet, comprising:
mixing a uranium oxide powder with an additive powder comprising a Ca compound and an Al compound at a molar ratio ranging from 10:90 to 90:10, thus preparing a mixed powder;
subjecting the mixed powder to compression molding, thus producing a green pellet; and
sintering the green pellet at 1600 to 1850° C. in a reducing gas atmosphere.

10. The method of claim 9, wherein the Ca compound and the Al compound are CaCO₃ and Al₂O₃, respectively.

11. The method of claim 9, wherein the CaCO₃ powder is sintered in a reducing gas atmosphere to thus be converted into CaO.

12. The method of claim 7, wherein the uranium oxide powder comprises a UO₂ powder with or without at least one selected from the group consisting of a PuO₂ powder, a Gd₂O₃ powder, a ThO₂ powder, and an Er₂O₃ powder.

13. The method of claim 7, wherein in the sintering, the reducing gas is a hydrogen-containing gas.

14. The method of claim 13, wherein the hydrogen-containing gas is a mixed gas comprising a hydrogen gas and at least one gas selected from the group consisting of carbon dioxide, water vapor, and an inert gas.

15. The method of claim 13, wherein the hydrogen-containing gas comprises a hydrogen gas alone.

16. The method of claim 9, wherein the uranium oxide powder comprises a UO₂ powder with or without at least one selected from the group consisting of a PuO₂ powder, a Gd₂O₃ powder, a ThO₂ powder, and an Er₂O₃ powder.

17. The method of claim 9, wherein in the sintering, the reducing gas is a hydrogen-containing gas.
